(19) United States
(12) Patent Application Publication
(10) Pub. No.: US 2014/0362218 A1
(43) Pub. Date: Dec. 11, 2014

(54) ELECTROMAGNETIC RADIATION TRANSMISSION LOCATION SYSTEM

(71) Applicants: William Meadow, Jacksonville, FL (US); Darryl Rosenberger, Jacksonville, FL (US)

(72) Inventors: William Meadow, Jacksonville, FL (US); Darryl Rosenberger, Jacksonville, FL (US)

(21) Appl. No.: 13/912,049

(22) Filed: Jun. 6, 2013

(51) Int. Cl. G01C 11/04

(52) U.S. Cl. CPC G01C 11/04
USPC 348/144

(57) ABSTRACT

The present invention apparatus, software and methods for capturing EMR data and correlating the EMR data with image data of a geographic area. The EMR data may be captured from one or both of a ground based system and an aerial based system. The EMR data may also be coupled with multiple image capture.

### FIELD OF INVENTION

The present invention relates to methods and apparatus of locating a transmitting point of electromagnetic radiation. More specifically, the present invention relates to methods and apparatus for conducting low altitude aerial data capture of electromagnetic radiation transmission, calculating a location of such electromagnetic radiation transmission and guiding ground based personnel to the point of transmission.

### BACKGROUND OF THE INVENTION

As populated areas increasingly include more and more use of electronic equipment, including equipment for transmitting and receiving electrical signals, such as, for example digital data associated with the Internet and entertainment channels (TV, music and “talk radio” stations), the opportunity for unintended transmission also increases. Unwanted transmission may include, for example, leakage from a cable system or cellular network meant to provide entertainment data streams and Internet access.

Unintended transmission of EMR is undesirable because it degrades the quality of intended delivery of data and also may interfere with other legitimate radio frequency transmissions. Accordingly, surveillance efforts are conducted to diligently ascertain EMR leakage and provide a location of such leakage so that appropriate service personnel may address the leakage. Due to the large geographic areas that need to be covered in order to provide meaningful surveillance, aerial monitoring of EMR transmission has developed to locate inadvertent EMR transmission. According to the present invention, aerial monitoring may be combined with Fly-By Imagery to facilitate technicians or other ground based personnel in locating of an EMR leak.

Generally, an aircraft may fly over a designated area and include an antenna and receiving equipment tuned to a wavelength that indicates a leak of EMR from a cable service. However, such leakage designations are limited to a general area of a detected EMR leak. Ground based personnel must still be proficient at leak detection to ascertain and address known leaks.

### SUMMARY DESCRIPTION OF THE INVENTION

Accordingly, the present invention provides apparatus, software and methods for capturing EMR data and correlating the EMR data with image data of a geographic area. In some embodiments, the EMR data may be captured from one or both of: a ground based system and an aerial based system. Similarly, in various embodiments, image data may be captured via one or both of: a ground based system and an aerial based system.

In some embodiments, the present invention provides an apparatus that enables a broad field of EMR and image capture coverage, low equipment weight and relatively low frontal surface area on a camera pod mounted under a general aviation aircraft.

In another aspect, the present invention provides a camera system that encases a plurality of cameras, wherein the cameras are arranged to provide a wide variety of different orientations of image capture. The arrangement and number of cameras enables the obtainment of a desired field of view, and in some embodiments, a maximum field of view of image capture from an aircraft.

Still other aspects include an aerodynamically contoured covering that has a variety of view ports. Each view port may be associated with a lens of an image capture device. Preferably, the image capture devices are arranged in a generally linear pattern which follows a forward to aft orientation of an aircraft to which the image capture devices are attached.

### DESCRIPTION OF THE DRAWINGS

The accompanying drawings, that are incorporated in and constitute a part of this specification, illustrate several embodiments of the invention and, together with the description, serve to explain the principles of the invention:

FIG. 1 illustrates a block diagram of system components that may be used in some implementations of the present invention.

FIG. 2 illustrates an overhead view and multiple camera views for capturing image data associated with a geographic area that may be used in some implementations of the present invention.

FIG. 3 illustrates an exemplary map of a designated geographic area that may be used in some implementations of the present invention.

FIG. 4 illustrates an exemplary report indicating EMR leakage.

FIG. 5 illustrates an exemplary camera arrangement for underneath an aircraft that may be used in some implementations of the present invention.

FIG. 6 illustrates a block diagram of a geographic area and sources of EMR leakage.

### DETAILED DESCRIPTION OF THE INVENTION

The present invention methods and apparatus for deploying data capture systems on manned and unmanned aircraft, wherein the data capture systems include image capture apparatus and other monitoring systems, such as EMR detection systems. The present invention provides meaningful combinations of two or more otherwise disparate layers of data. Combinations may include, for example two or more of: EMR leakage data; geospatial designation data; aerial image data; and mapping data.

In various embodiments, manned or unmanned aircraft may be utilized. A selection of a manned or unmanned aircraft type will involve inherent tradeoffs. Considerations may include for example, an aircraft's ability to sustain equipment size, weight, orientation, and power requirements. Available power and a size of an aircraft must be considered in deploying equipment and unmanned aircraft may be constrained to low altitude flight paths and a very limited amount of weight and electrical power that the unmanned aircraft may provide to data capture systems.

According to the present invention, aircraft monitor survey geographic areas for EMR transmission within a specified bandwidth. In some embodiments EMR may be monitored for a specified signal pattern. A location of a monitored EMR signal is associated with image data captured from the aircraft.

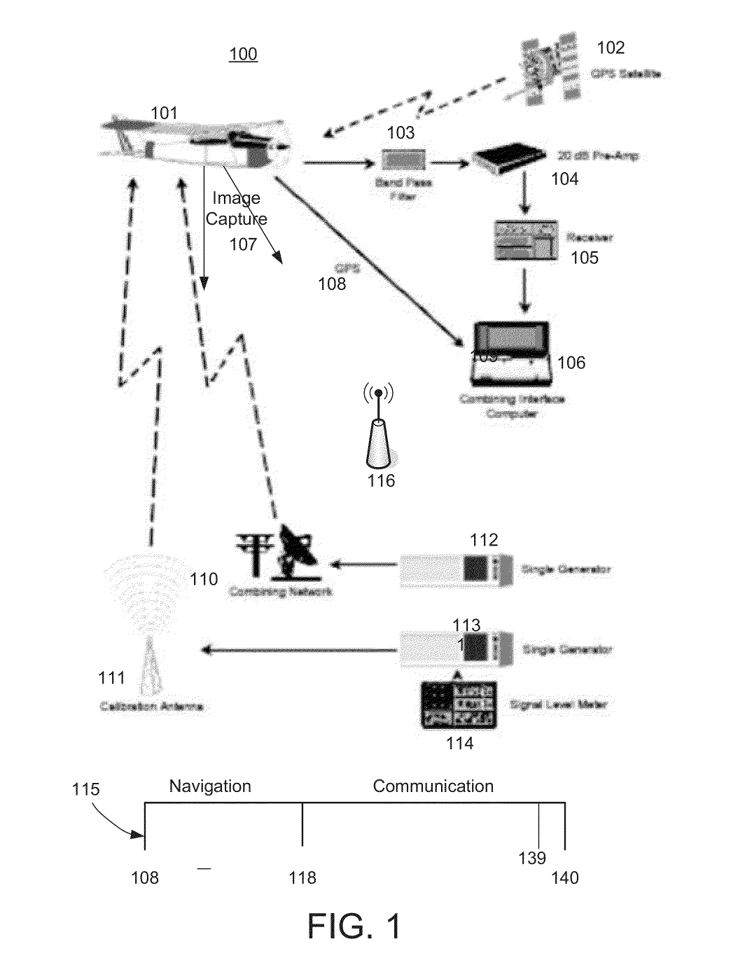

Referring now to FIG. 1, a system 100 for monitoring EMR and collecting image data may include apparatus and software for implementing specific method steps. As illustrated, an aircraft 101 may be flown over an area in which EMR will be monitored. The aircraft may generate location data, such as Cartesian coordinates from a system, such as the Global Positioning Satellite (GPS) system 102. The aircraft may also include EMR monitoring equipment, such as an antenna (not illustrated) connected to a Band Pass Filter 103. The Band Pass Filter 103 may be used to select a frequency (F) of EMR to monitor. A detected EMR signal may be fed into a Pre-Amp 104 and passed on to a Receiver 105. The Receiver 105 may provide an accurate measurement of one or more of: an amplitude of a detected signal, a duration of a detected signal, a pattern of a detected signal and a Frequency of a detected signal.

In some embodiments, a Receiver 105 may include multiple frequency scanner may also be used, for example, in monitoring leakage or unauthorized transmission from a wireless data network 116, such as a cellular network.

A combining interface computer 106 may receive EMR data from the Receiver 105 and GPS data 108 from the aircraft 101 and store received data so that it may be one or more of: correlated, post processed, and transmitted.

In some embodiments, a signal generator may be connected to one or both of a cable network and a combining network 110 and pump a test signal through a ground based cable network. The signal generator provides for a specific signal pattern which may be monitored for by the equipment 103-106 included in the aircraft 101. The test signal may include, for example, a signal at 133.2 MHz. The test signal may also include one or both of an audio signal and a video signal. The test signal may be useful to distinguish EMR leakage which is a transmission from a targeted cable network as compared to a competitor's cable network.

Embodiments may also include a signal generator 112 combined with a signal level marker 114 which may be transmitted via a calibration antenna 111. The calibration antenna may be used to calibrate one or more of the: Band Pass Filter 103, the pre-Amp 104 and the Receiver 105. In some preferred embodiments, the one or more of the: Band Pass Filter 103, the pre-Amp 104 and the Receiver 105 may be tuned to an aeronautical band 108-140 MHz Frequency, including, between 108 MHz and 118 MHz which detects for interference on a bandwidth allocated for aeronautical navigation signals and/or between 118 MHz and 140 MHz which is a bandwidth allocated for aeronautical communication.

According to the present invention, a GPS satellite 102 provides GPS coordinates to an aircraft 101 and the aircraft captures images (as discusses more fully below) of a geospatial area and logs the GPS coordinates associated with captured image data. The captured image data is typically captured simultaneously from multiple cameras pointed in multiple directions. In addition, the captured image data is associated with EMR data. If EMR data indicates a level of EMR above predetermined threshold (an “EMR leak”), the location of the EMR exceeding the threshold is stored and also associated with image data for the same location.

A ground based service technician or other personnel may be directed to the location of and EMR leak and also provided with imagery of a location corresponding with the EMR leak data. In some embodiments, the service technician may be guided to the site of the EMR leak via the provision of combined layers of data, such as, for example, two or more of: GPS data; aerial based image data; ground based image capture data; EMR data; cable routing data; map data, aerial network equipment layout data; cable routing data and/or images, equipment location data and/or images, junction data and/or images, points of demarcation of fiber optic to copper based carrier, or a location of other connection points.

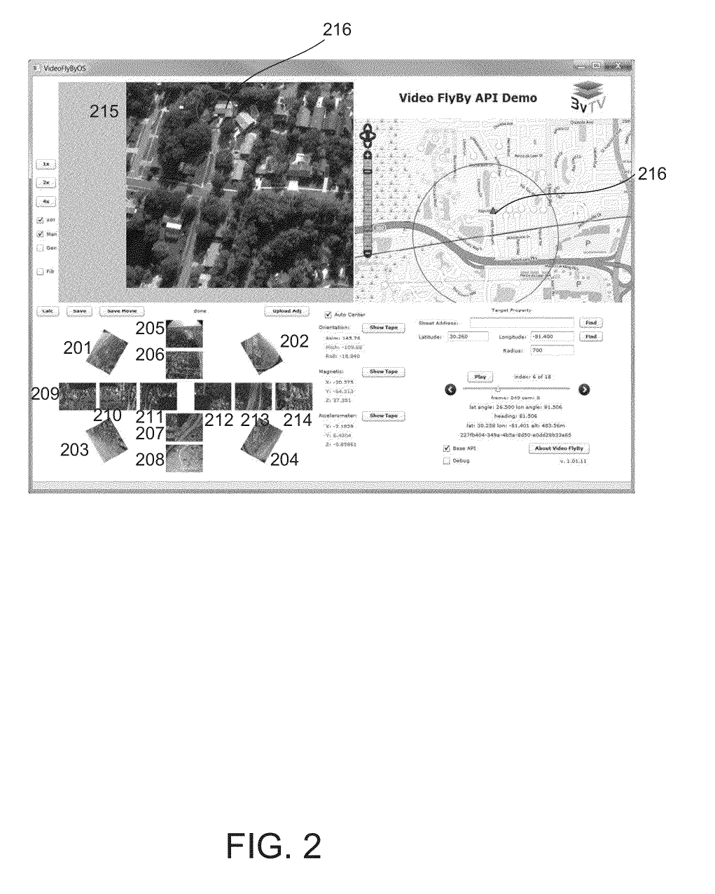

Referring now to FIG. 2, an example of a configuration of multiple camera scope of image capture 201-214 is illustrated in relation of one scope of image capture 201-214 to one another scope of image capture 250-214. Multiple image capture devices may be fixedly aligned on an image capture mounting frame along a generally linear path, wherein each of the multiple image capture devices includes a scope of image capture directed to a point away from one side of a geometric plane tangential to an underside of the aerial vehicle. As illustrated, in some embodiments, twelve or more, such as fourteen cameras may be arranged on a camera mounting frame such that each camera is directed in a unique direction.

In some preferred embodiments, image capture devices are arranged such that a first array of between four (4) eight (8) scopes of image capture 209-214 (associated with a first set of image capture devices included in a linear array of between four (4) and twenty (20) image capture devices, and preferably fourteen (14) image capture devices), are orthogonally crossed by a second array of between four (4) eight (8) scopes of image capture 205-208 (associated with a second set of image capture devices included in a linear array of between four (4) and twenty (20) image capture devices, and preferably fourteen (14) image capture devices).

In addition, one or more scopes of image capture 201-204 may be arranged at an angle between 0° and 90° of the first array of scopes of image capture 209-214 and the second array of scopes of image capture 205-208. As illustrated a downward forward camera 206 and a downward rear camera 207 may also be included. Such scopes of image capture 201-204 arranged at an angle between 0° and 90° of the first array of scopes of image capture 209-214 and the second array of scopes of image capture 205-208, may, for example, be at about a 45° angle to a first array or a second array of scopes of image capture. Other exemplary scopes of image capture may include an angle of about 300° 201, 0° 205, 60° 202, 120° 204, 150° 208 and 240° 203.

According to the present invention, a subject location 216, which indicates an EMR leakage area, may be identified, and image capture devices may be positioned such that one or more of the scopes of image capture 201-214 will capture the subject 216. Image data of the subject 216 may be identified among frames of image data captured by one or more of the image capture devices. Preferably, a flight plan will include a path which allows more than one scopes of image capture 201-214 which capture image data of the subject during the aircraft flight.

In some embodiments, image capture devices, such as cameras, are positioned to enable image capture of an aerial level view of a neighborhood surrounding a selected geographic location during flight of the aircraft.

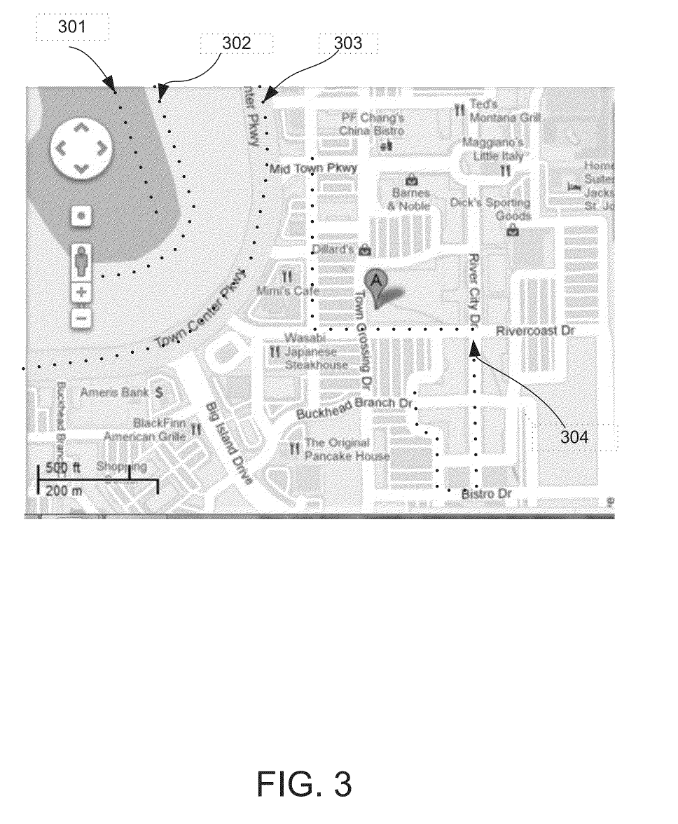

Referring now to FIG. 3, an exemplary map is illustrated with map based flight patterns. As illustrated, a manned or unmanned aircraft may fly on a flight path determined by map features, such as, for example, based upon a water side of a shoreline 301, based upon a shore side of a shoreline 302. Other flight paths may be based upon roadways 303-304. Some preferred embodiments may include an unmanned aircraft flying at altitudes of 250 feet or less above ground level and following street designations on a map.

An unmanned aircraft may include, by way of non-limiting example, a remote controlled airplane, a remote controlled helicopter, a remote controlled inflatable aircraft or other type of unmanned aircraft.

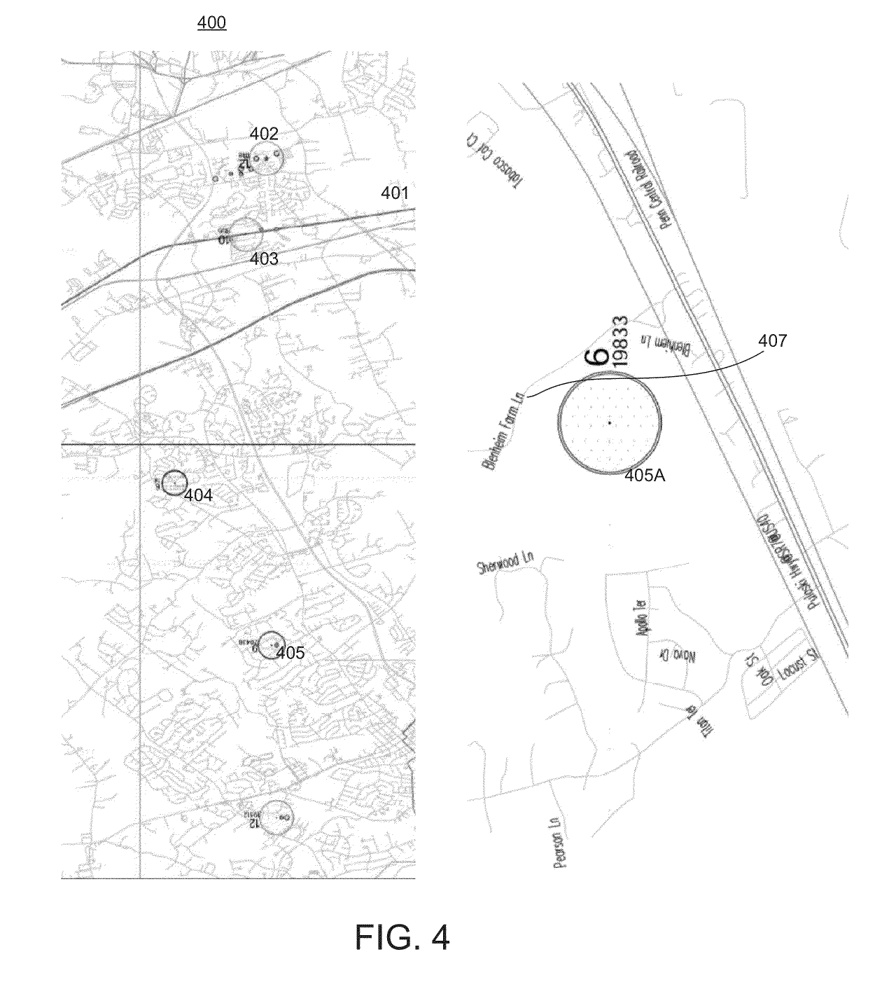

Referring now to FIG. 4, an exemplary report 400 based upon manned or unmanned aggregating of multiple payers of data is shown. A map, 401 includes highlighted areas 402-405 where levels of EMR data exceeded a threshold amplitude in a predetermined Frequency range, essentially, an indication of an EMR leak. The report 400 overlays the EMR leak indications 402-405 onto a map indicating geospatial locations.

A close up of an EMR leak indication 405A is indicative of assistance that may be provided to ground based service technicians by indicating a nearby street 407. Other indications may also be included, such as image data. Image data may be captured via cameras mounted on manned or unmanned aircraft.

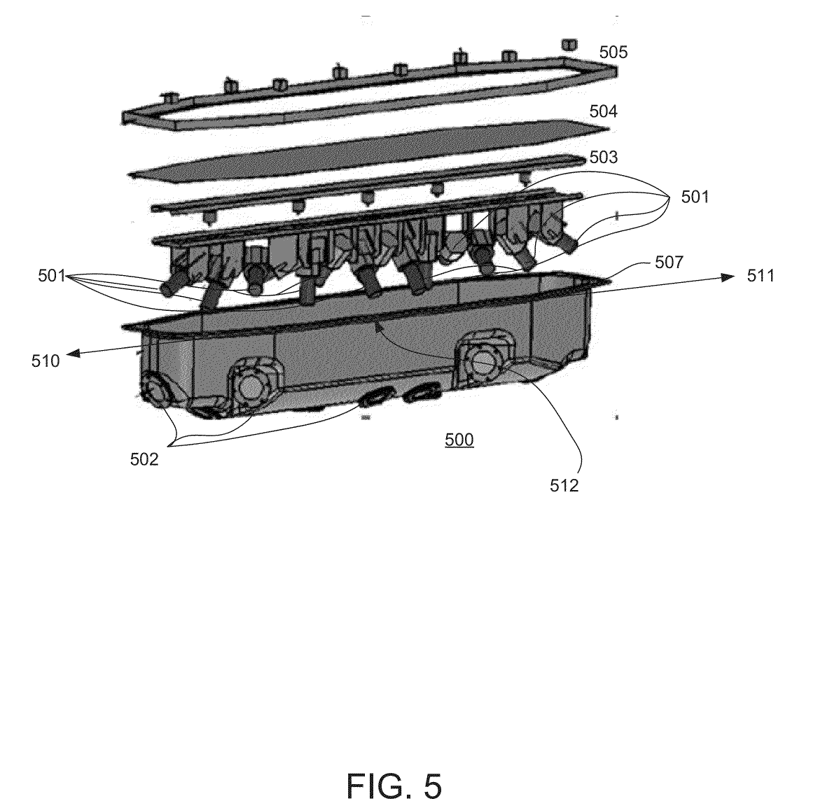

Referring now to FIG. 5, in one aspect of the present invention an array of cameras, or other image capture devices may be utilized to capture image data. The cameras may be arranged in an apparatus suitable for mounting on an aircraft for image capture during flight of the aircraft. The image capture devices may be fixedly mounted in relation to each other and include multiple image capture perspectives. The present invention additionally includes an aerodynamic shroud or covering to reduce wind drag during flight and protect against wind and water damage. In addition, in some embodiments, the present invention includes cameras which are fixedly mounted to the structure of the aircraft and move with the aircraft in terms of pitch, yaw and roll, as well as forward and elevationally

An exemplary camera apparatus assembly 500 according to some embodiments of the present invention is illustrated. As illustrated, multiple cameras 501 are mounted to a camera mounting frame 503. The camera mounting frame 503 fixedly secures the cameras 501 such that the cameras 501 are focused in multiple directions. In some embodiments, each camera 501 is focused in a unique direction as compared to the other cameras. In additional embodiments, redundant cameras may be directed in a same direction such that more than one camera 501 is focused in a single direction. However, it is generally preferable that multiple cameras are focused in multiple directions, whether some redundancy exists or not. Some embodiments may additionally include cameras 501 that are focused in overlapping areas.

Preferably, the cameras 501 are arranged in a generally linear formation, such as, from a first point 510 in a forward direction of an aircraft, and a second point 511 in an aft position. The linear arrangement of image capture devices 501, such as cameras, provides for decreased aerodynamic resistance of the array 500 during flight of the aircraft on which the image capture devices are mounted.

In some embodiments, midpoint 512 is defined wherein a generally linear array of image capture devices 501 are arranged to provide multiple scopes of image capture (illustrated in FIG. 2) in a fore and aft direction.

In another aspect, some embodiments may include a gasket 504 or other vibration insulator that may be placed in position between the camera mounting fame 503 and a housing mount 505. The gasket may include a neoprene, silicone, polymer, cork or other material which will absorb vibration inherent in the operation of the aircraft. The housing mount includes a frame for fixedly mounting the camera apparatus assembly 500 to an aircraft. In some embodiments, an active computer controlled stabilizer mechanism may be included and be functional to reduce vibration.

A camera housing 507 is included to provide a protective covering 507 for the multiple cameras 501. Preferred embodiments include protective covering 507 that more aerodynamically efficient as compared to uncovered cameras mounted on the camera mounting frame 503. The protective covering may be any rigid or semi-rigid material, such as, for example aluminum or a thermoplastic material. A In some embodiments, a thermoplastic may be preferred due to the relative lightweight properties and ruggedness of such materials.

One exemplary thermoplastic material includes Acrylonitrile butadiene styrene (ABS) (chemical formula (C₈H₈)ₓ.(C₄H₆)_{y}.(C₃H₃N)_{z}). Important mechanical properties of ABS include its inherent impact resistance and toughness. In some embodiments, the impact resistance of the ABS may be increased for the use as a protective covering 507 by increasing a proportion of polybutadiene in relation to styrene and also acrylonitrile. Another preferable quality of a protective covering 507 material is that the impact resistance should not fall off rapidly at lower temperatures.

An airplane or other aircraft may travel from sea level to high altitudes and encounter significant temperature changes during such travel. The protective covering needs to be functional for all temperature ranges encountered. Accordingly, a grade of aluminum which is able to withstand conditions with temperature ranges of 70 degrees Celsius to minus 20 degrees Celsius with minimal distortion is preferred is aluminum is included as a protective cover.

Additional materials that may be useful as a protective covering may include, for example, clear thermoplastic, acrylic, aluminum, stainless steel, carbon fiber or other aircraft quality material. In some embodiments including a protective cover 507 with an opaque material, view portals 502 may be included in the protective covers 507, wherein the view portals 502 include a material transparent to a wavelength of light utilized by the image capture devices 501 to capture image data.

In some embodiments, image capture devices, such as cameras 501 capture images based upon a wavelength of light in a spectrum viewable by the human eye (generally including wavelengths from about 390 to 750 nm, in terms of frequency, this corresponds to a band in the vicinity of 400-790 THz), other embodiments may include image capture devices, such as cameras 501 which capture images based upon an infrared wavelength (0.8-5000 μm), microwave wavelength, ultraviolet wavelength (50 nm to 400 nm) or other wavelength outside the spectrum viewable by the human eye.

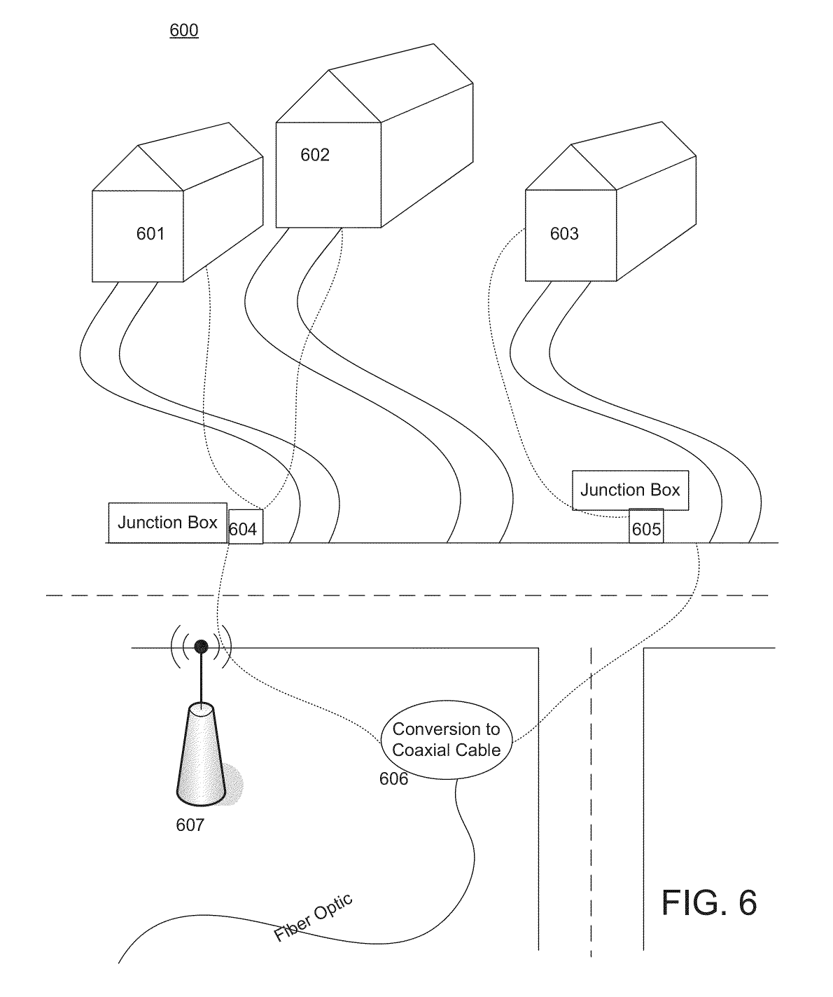

Referring now to FIG. 6, an exemplary overlay 600 may also include a location of structures 601-603 which may be used to help identify a possible point of EMR leakage. Other possible leakage points may include, for example, one or more equipment components, such as, for example: a cable junction box 604-607, a conversion point 606 where fiber optic data transfer medium to a copper based cable, such as coaxial cable; and a cellular tower 607 or antenna 607. An overlay 600 and associated data may be stored, for example in a database and related to a map or other geospatial indicator. In addition, image data associated with the geospatial area may be associated with particular geospatial areas.

In some embodiments, data may be stored in layers, such as a first layer including image data related to one or more geospatial areas and/or images of components which are potential sources of leakage 601-607. Another layer may include equipment types and components. Still another layer may include an electromagnetic leakage profile associated with particular types of equipment

Various additional embodiments of the invention may include enhancements to image data captured by an array of image capture devices arranged or combination of video fly-by data with other data sources related to the geographic location. For example, enhancements to image data captured by an array of cameras fixedly attached to an aircraft may include: 1) providing accurate differential GPS data; 2) post processing of geo positioning signals to smooth curves due to motion (sometimes referred to as splines); 3) highly accurate camera position and video frame position analysis processing to provide a calculation of the exact position of each video frame; 4) parcel data processing that analyses vector line data that is geo-coded with latitude and longitude values; 5) digital image photos processed with image superimposition algorithms; and 6) a database that includes video image files; parcel latitude and longitude data; and positioning data that is indexed to image data files. With these components, the invention enables the access to video images of any desired geographic location and its surrounding neighborhood, while relating such image data to other property related data such as property lines, landmarks, etc.

While the invention has been described in conjunction with specific embodiments, it is evident that many alternatives, modifications and variations will be apparent to those skilled in the art in light of the foregoing description. Accordingly, this description is intended to embrace all such alternatives, modifications and variations as fall within its spirit and scope.

what is claimed is:

1. Apparatus for providing a location of an electromagnetic radiation leak, the apparatus comprising:
a processor in logical communication with a storage device storing executable software, said executable software being executable upon demand to cause the processor to:
receive a flight pattern over a geographic area comprising electromagnetic radiation;
receive a sequence of image data captured from an aircraft;
receive a sequence of electromagnetic radiation data captures;
record geospatial coordinates at sequential times of capture of the image data and the electromagnetic radiation data captures;
ascertain one or more electromagnetic radiation data captures which exceed a predetermined threshold;
determine one or more geospatial location corresponding with one or more electromagnetic radiation data captures which exceed a predetermined threshold; and
provide image data descriptive of the geospatial location corresponding with one or more electromagnetic radiation data captures which exceed a predetermined threshold.

2. The apparatus of claim 1 wherein the controller comprises a processor and a storage device and executable software stored on the storage device, said executable software executable on demand, wherein the software is operative with the processor to cause the one or more of the image capture devices to:
generate digital data comprising two or more images of a subject location comprising one or more geospatial locations corresponding with one or more electromagnetic radiation data captures which exceed a predetermined threshold, wherein the images are captured by one or more cameras fixedly attached to an aerial vehicle, and the two or more images are captured from disparate points on a continuum traversed by the aerial vehicle in flight.

3. The apparatus of claim 1 additionally comprising a device for designating Cartesian coordinates indicating a location of the array.

4. The apparatus of claim 3 wherein the device for designating Cartesian coordinates indicating a location of the array comprises a Global Positioning Satellite device.

5. The apparatus of claim 4 wherein the image capture devices comprise cameras fixedly mounted to an underside of an aircraft.

6. The apparatus of claim 5 wherein the image capture devices capture images utilizing multiple light spectrums.

7. The apparatus of claim 5 wherein at least one image capture device captures images utilizing a visible light spectrum of humans.

8. The apparatus of claim 5 wherein at least one image capture device captures images utilizing an infrared light spectrum.

9. The apparatus of claim 8 wherein the light filter enhances a contrast of a feature in a captured image.

10. The apparatus of claim 5 wherein the array comprises a first row of at least six cameras linearly aligned.

11. A method for providing a location of an electromagnetic radiation leak, the apparatus comprising:
receiving a flight pattern over a geographic area comprising electromagnetic radiation into a processor executing executable software;
receiving into the processor a sequence of image data captured from an aircraft;
receiving into the processor a sequence of electromagnetic radiation data captures;
recording into the processor a set of geospatial coordinates at sequential times of capture of the image data and the electromagnetic radiation data captures;
ascertaining with the processor one or more electromagnetic radiation data captures which exceed a predetermined threshold;
determining with the processor one or more geospatial location corresponding with one or more electromagnetic radiation data captures which exceed a predetermined threshold; and
providing with the processor image data descriptive of the geospatial location corresponding with one or more electromagnetic radiation data captures which exceed a predetermined threshold.

12. The method of claim 11 wherein the controller comprises a processor and a storage device and executable software stored on the storage device, said executable software executable on demand, wherein the software is operative with the processor to cause the one or more of the image capture devices to:
generate digital data comprising two or more images of a subject location comprising one or more geospatial locations corresponding with one or more electromagnetic radiation data captures which exceed a predetermined threshold, wherein the images are captured by one or more cameras fixedly attached to an aerial vehicle, and the two or more images are captured from disparate points on a continuum traversed by the aerial vehicle in flight.

13. The method of claim 11 additionally comprising the step of designating Cartesian coordinates indicating a location of the array.

14. The method of claim 13 additionally comprising the step of designating Cartesian coordinates indicating a location of the array comprises a Global Positioning Satellite device.

15. The method of claim 14 wherein the image capture devices comprise cameras fixedly mounted to an underside of an aircraft.

16. The method of claim 15 additionally comprising the step of capturing images utilizing multiple light spectrums.

17. The method of claim 15 additionally comprising the step of capturing images utilizing a visible light spectrum of humans.

18. The method of claim 15 additionally comprising the step of captures images utilizing an infrared light spectrum.

19. The method of claim 15 additionally comprising the step of enhancing a contrast of a feature in a captured image with a light filter.

20. The method of claim 15 wherein the array comprises a first row of at least six cameras linearly aligned.
